(19) United States
(12) Patent Application Publication
(10) Pub. No.: US 2025/0216201 A1
(43) Pub. Date: Jul. 3, 2025

(54) GYRO SENSOR AND METHOD FOR CONTROLLING GYRO SENSOR

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Keitaro ITO, Nisshin-shi (JP); Shota HARADA, Nisshin-shi (JP)

(21) Appl. No.: 18/913,569

(22) Filed: Oct. 11, 2024

(30) Foreign Application Priority Data
Dec. 27, 2023 (JP) 2023-221265

(51) Int. Cl. G01C 19/5776; G01C 19/00; G01C 25/00

(52) U.S. Cl. CPC G01C 19/5776; G01C 25/00; G01C 19/005

(57) ABSTRACT

A gyro sensor includes a resonator and a control unit that executes drive control of the resonator. The control unit includes a PLL, an AGC, a detection gain ratio corrector and a drive gain ratio corrector. The detection gain ratio corrector corrects a detection gain ratio between a gain of a first detection signal from a first detection electrode that detects vibration of the resonator on the x axis and a gain of a second detection signal from a second detection electrode that detects vibration of the resonator on the y axis. The drive gain ratio corrector corrects a drive gain ratio between a gain of a first drive signal to a first drive electrode for vibrating the resonator in the first vibration mode and a gain of a second drive signal to a second drive electrode for vibrating the resonator in the second vibration mode.

### CROSS REFERENCE TO RELATED APPLICATION

This application is based on Japanese Patent Application No. 2023-221265 filed on Dec. 27, 2023, the disclosure of which is incorporated herein by reference.

### TECHNICAL FIELD

The present disclosure relates to a gyro sensor and a method for controlling a gyro sensor.

### BACKGROUND

A gyro sensor includes a resonator having two vibration modes having different resonance angle frequencies, a mounting substrate surrounding the resonator and including electrodes for driving and detecting vibration, and a control unit that executes drive control.

### SUMMARY

According to an aspect of the present disclosure, a gyro sensor includes: a resonator having a first vibration mode and a second vibration mode having different resonance angle frequencies; a mounting substrate including a plurality of electrodes facing the resonator; and a control unit that executes drive control of the resonator. A radial direction is defined about a virtual straight line along a thickness direction of the mounting substrate and passing through a center of a region surrounded by the plurality of electrodes. An x axis being the radial direction along a vibration direction of the first vibration mode, and a y axis being the radial direction along a vibration direction of the second vibration mode. The control unit includes a PLL that drives the resonator in two axes of the first vibration mode and the second vibration mode, a detection gain ratio corrector that corrects a detection gain ratio that is a ratio between a gain of a first detection signal from a first detection electrode that detects vibration of the resonator on the x axis among the plurality of electrodes and a gain of a second detection signal from a second detection electrode that detects vibration of the resonator on the y axis among the plurality of electrodes, a first coordinate converter that converts a signal from the detection electrode from an actual coordinate axis into a coordinate axis for calculation with a planar coordinate axis formed by the radial direction as the actual coordinate axis, a drive gain ratio corrector that corrects a drive gain ratio that is a ratio between a gain of a first drive signal to a first drive electrode for vibrating the resonator in the first vibration mode among the plurality of electrodes and a gain of a second drive signal to a second drive electrode for vibrating the resonator in the second vibration mode among the plurality of electrodes, a second coordinate converter that converts a signal corrected by the drive gain ratio corrector from the coordinate axis for calculation into the actual coordinate axis, a first demodulation block that calculates a demodulation output used to calculate the detection gain ratio on a basis of the first detection signal, a second demodulation block that calculates a demodulation output used to calculate the detection gain ratio on a basis of the second detection signal, an AGC that calculates a drive output that maintains a vibration amplitude of the resonator in the first vibration mode and the second vibration mode, and an angle feedback unit that includes an integration circuit to calculate, on a basis of information of an angular velocity input from the AGC, a rotation angle by an integration calculation of the angular velocity after the detection gain ratio and the drive gain ratio are corrected, and feeds back the rotation angle calculated to the first coordinate converter and the second coordinate converter.

According to another aspect of the present disclosure, a method for controlling the gyro sensor includes: driving the resonator in two axes of the first vibration mode and the second vibration mode by two independent PLLs and AGCs; calculating and determining a detection gain ratio that is a ratio between a gain of a first detection signal from a first detection electrode that detects vibration of the resonator on an x axis among the plurality of electrodes and a gain of a second detection signal from a second detection electrode that detects vibration of the resonator on a y axis among the plurality of electrodes, the x axis being a radial direction along a vibration direction of the first vibration mode, the y axis being a radial direction along a vibration direction of the second vibration mode, the radial direction being defined about a virtual straight line along a thickness direction of the mounting substrate and passes through a center of a region surrounded by the plurality of electrodes; calculating and determining a drive gain ratio that is a ratio between a gain of a first drive signal to a first drive electrode for vibrating the resonator on the x axis among the plurality of electrodes and a gain of a second drive signal to a second drive electrode for vibrating the resonator on the y axis among the plurality of electrodes; calculating, by a demodulation block, a demodulation output based on the first detection signal and the first drive signal, a demodulation output based on the first detection signal and the second drive signal, a demodulation output based on the second detection signal and the first drive signal, and a demodulation output based on the second detection signal and the second drive signal; after determining the detection gain ratio, calculating a deviation angle that is an angle between a vibration axis and an electrode axis of the resonator on a basis of a result of calculation in the demodulation block and performing feedback control of the deviation angle, the x axis and the y axis being the vibration axis, the electrode axis being the radial direction along a drive electrode for driving in the first vibration mode and the second vibration mode among the plurality of electrodes; calculating Af that is a difference between resonance frequencies of the first vibration mode and the second vibration mode on a basis of a frequency signal corresponding to the first vibration mode and a frequency signal corresponding to the second vibration mode output from the two independent PLLs and performing feedback control of the Af after performing the feedback control of the deviation angle; calculating a rotation angle of the gyro sensor by an integral calculation of an angular velocity after performing the feedback control of the Af and determining the drive gain ratio, and feeding back the rotation angle calculated to calculation of a rotation angle in a detection direction and a rotation angle in a drive direction of vibration of the resonator; and measuring an angle and an angular velocity of the gyro sensor after feeding back the rotation angle.

### BRIEF DESCRIPTION OF DRAWINGS

FIG. 1 is a perspective view illustrating an exemplary structure of a sensor element in a gyro sensor.

FIG. 2 is a sectional view illustrating a sectional configuration taken along line II-II in FIG. 1.

FIG. 3 is a diagram corresponding to FIG. 2, and is a sectional view illustrating another exemplary structure.

FIG. 4 is an explanatory diagram of a vibration axis and an electrode axis of the sensor element.

FIG. 5 is a diagram illustrating a two-dimensional vibration model of a resonator of the gyro sensor.

FIG. 6 is a block diagram illustrating a configuration of a gyro sensor according to an embodiment.

FIG. 7 is a block diagram illustrating a circuit configuration of a deviation angle corrector.

FIG. 8 is a block diagram illustrating a circuit configuration of a mode match control unit.

FIG. 9 is a block diagram illustrating a circuit configuration of an angle feedback unit.

FIG. 10 is an explanatory diagram of a first vibration mode and a second vibration mode in the resonator vibrating in a wineglass mode.

FIG. 11 is an explanatory diagram of a demodulation output calculated by a demodulation block.

FIG. 12 is a diagram illustrating a relationship between a demodulation output, an output waveform, and Ow polarity.

FIG. 13 is an explanatory diagram of first calculation of the detection gain ratio.

FIG. 14 is an explanatory diagram of second calculation of the detection gain ratio.

FIG. 15 is an explanatory diagram of third calculation of the detection gain ratio.

FIG. 16 is an explanatory diagram of calculation of a drive gain ratio.

FIG. 17 is a flowchart illustrating a processing example of reducing an error of a measurement angle.

### DESCRIPTION OF EMBODIMENTS

A gyro sensor detects an angle of rotation applied to a resonator in a state where the resonator vibrates in a first vibration mode and a second vibration mode by a control scheme called a whole angle mode.

The whole angle mode is advantageous in that angle information of the rotation can be acquired and a range of an angular velocity input to the resonator can be increased. A resonator in this type of gyro sensor can be regarded as a two-dimensional vibration model of a two-degree-of-freedom system in which two vibration axes having predetermined spring constants orthogonal to a mass point and two damping axes having predetermined damping coefficients orthogonal to the mass point are connected on a two-dimensional plane along a mounting substrate on which the resonator is mounted. At this time, assuming that the angle of rotation in the whole angle mode is θ, the angular velocity is expressed by the following equation (1).

$$\dot{θ} \approx - ηΩ + \frac{1}{2} Δ ( \frac{1}{τ} ) sin 2 ( θ - {θ}_{τ} ) \frac{E}{\sqrt{{E}^{2} - {Q}^{2}}} + \frac{1}{2} Δω cos 2 ( θ - {θ}_{ω} ) \frac{E}{\sqrt{{E}^{2} - {Q}^{2}}} \qquad ( 1 )$$

In the equation (1), η is an angular gain, T is a time constant, θ_{T} is an angle formed by a damping axis of a resonator and an electrode axis, θ_{ω} is an angle formed by a vibration axis and an electrode axis of a resonator, Q is energy of unnecessary vibration called a quadrature error, Δω is a difference between resonance angle frequencies of two vibration axes, and E is vibration energy.

In the equation (1), in the whole angle mode, an error occurs in a measurement angle due to an error of a time constant depending on a frequency error and a Quality factor of the resonator, called angle dependent bias. The two vibration axes of the resonator are set as the x axis and the y axis, and a gain error of a drive signal between an x axis and a y axis and a gain error of a detection signal of vibration occur due to a fabrication error of the resonator and the like, and thus, these gain errors become an error factor of the measurement angle in the whole angle mode.

The present disclosure provides a gyro sensor that is controlled in a whole angle mode and can reduce an error in a measurement angle caused by a gain error of a drive signal and a gain error of a vibration detection signal between two vibration axes of a resonator, and a method for controlling the gyro sensor.

A gyro sensor includes: a resonator having a first vibration mode and a second vibration mode having different resonance angle frequencies; a mounting substrate including a plurality of electrodes facing the resonator; and a control unit that executes drive control of the resonator. When a radial direction that passes through a center of a region surrounded by the plurality of electrodes and has, as an axis, a virtual straight line along a thickness direction of the mounting substrate includes a direction along a vibration direction of the first vibration mode as an x axis and a direction along a vibration direction of the second vibration mode as a y axis. The control unit includes a PLL that drives the resonator in two axes of the first vibration mode and the second vibration mode, a detection gain ratio corrector that corrects a detection gain ratio between a gain of a first detection signal from a first detection electrode that detects vibration of the resonator on the x axis among the plurality of electrodes and a gain of a second detection signal from a second detection electrode that detects vibration of the resonator on the y axis among the plurality of electrodes, a first coordinate converter that converts a signal from the detection electrode from an actual coordinate axis into a coordinate axis for calculation with a planar coordinate axis formed by the radial direction as the actual coordinate axis, a drive gain ratio corrector that corrects a drive gain ratio between a gain of a first drive signal to a first drive electrode for vibrating the resonator in the first vibration mode among the plurality of electrodes and a gain of a second drive signal to a second drive electrode for vibrating the resonator in the second vibration mode among the plurality of electrodes, a second coordinate converter that converts a signal corrected by the drive gain ratio corrector from the coordinate axis for calculation into the actual coordinate axis, a first demodulation block that calculates a demodulation output used to calculate the detection gain ratio on a basis of the first detection signal, a second demodulation block that calculates a demodulation output used to calculate the detection gain ratio on a basis of the second detection signal, an AGC that calculates a drive output that maintains a vibration amplitude of the resonator in the first vibration mode and the second vibration mode, and an angle feedback unit that includes an integration circuit to calculate, on a basis of information of an angular velocity input from the AGC, a rotation angle by an integration calculation of the angular velocity after the detection gain ratio and the drive gain ratio are corrected, and feeds back the rotation angle calculated to the first coordinate converter and the second coordinate converter.

In this gyro sensor, four demodulation outputs by a combination of one of detection signals and one of drive signals of two vibration modes are calculated by two demodulation blocks while the resonator is driven in each of the two vibration modes by two independent PLLs and AGCs. In this gyro sensor, on the basis of the demodulation outputs, the gain ratio of each of the detection signal and the drive signal of the x axis and the y axis of the resonator is corrected by a detection gain ratio corrector and a drive gain ratio corrector, and the influence of the gain ratio on the x axis and the y axis of the signal of drive and detection of the resonator is reduced. Therefore, the gyro sensor is controlled in the whole angle mode, and the error of the measurement angle caused by the gain ratio of the detection signal and the gain ratio of the drive signal is reduced.

A method for controlling a gyro sensor in which a resonator having a first vibration mode and a second vibration mode having different resonance angle frequencies is mounted on a mounting substrate including a plurality of electrodes facing the resonator includes: driving the resonator in two axes of the first vibration mode and the second vibration mode by two independent PLLs and AGCs; when a radial direction that passes through a center of a region surrounded by the plurality of electrodes and has, as an axis, a virtual straight line along a thickness direction of the mounting substrate includes a direction along a vibration direction of the first vibration mode as an x axis and a direction along a vibration direction of the second vibration mode as a y axis, calculating and determining a detection gain ratio between a gain of a first detection signal from a first detection electrode that detects vibration of the resonator on the x axis among the plurality of electrodes and a gain of a second detection signal from a second detection electrode that detects vibration of the resonator on the y axis among the plurality of electrodes; calculating and determining a drive gain ratio between a gain of a first drive signal to a first drive electrode for vibrating the resonator on the x axis among the plurality of electrodes and a gain of a second drive signal to a second drive electrode for vibrating the resonator on the y axis among the plurality of electrodes; calculating, by a demodulation block, a demodulation output based on the first detection signal and the first drive signal, a demodulation output based on the first detection signal and the second drive signal, a demodulation output based on the second detection signal and the first drive signal, and a demodulation output based on the second detection signal and the second drive signal; when the x axis and the y axis are vibration axes, and a direction extending along a radial direction that passes through a center of a region surrounded by the plurality of electrodes and has, as an axis, a virtual straight line along a thickness direction of the mounting substrate, and extending along a drive electrode for driving in the first vibration mode and the second vibration mode among the plurality of electrodes is an electrode axis, after determining the detection gain ratio, calculating a deviation angle between the vibration axis and the electrode axis of the resonator on a basis of a result of calculation in the demodulation block and performing feedback control of the deviation angle; calculating Δf that is a difference between resonance frequencies of the first vibration mode and the second vibration mode on a basis of a frequency signal corresponding to the first vibration mode and a frequency signal corresponding to the second vibration mode output from the two independent PLLs and performing feedback control of the Δf after performing the feedback control of the deviation angle; calculating a rotation angle of the gyro sensor by an integral calculation of an angular velocity after performing the feedback control of the Δf and determining the drive gain ratio, and feeding back the rotation angle calculated to calculation of a rotation angle in a detection direction and a rotation angle in a drive direction of vibration of the resonator; and measuring an angle and an angular velocity of the gyro sensor after feeding back the rotation angle.

In this method for controlling the gyro sensor, the resonator is driven in each of two vibration modes by two independent PLLs and AGCs, and four demodulation outputs are calculated by a combination of one of the detection signals and one of the drive signals in the two vibration modes by two demodulation blocks. In this method for controlling the gyro sensor, the detection gain ratio that is a gain ratio of detection signals of the x axis and the y axis of the resonator is determined by calculation on the basis of the demodulation output, and then the deviation angle between the vibration axis and the electrode axis of the resonator is calculated and feedback of the deviation angle is performed. In addition, in this gyro sensor control method, the difference Δf between the resonance frequencies is calculated and the feedback is performed on the basis of the two drive signals corresponding to the two vibration modes from the two PLLs, and a drive gain ratio that is a gain ratio of the drive signals of the x axis and the y axis is calculated and determined. In this method for controlling the gyro sensor, the angle and the angular velocity are calculated after the above processing is executed, and thus, the effect of reducing the error of the measurement angle caused by the gain ratio between the x axis and the y axis of the detection signal and the drive signal can be obtained.

Hereinafter, embodiments of the present disclosure will be described with reference to the drawings. In the following embodiments, the same or equivalent portions are denoted by the same reference signs, and the description thereof will be made.

### First Embodiment

A gyro sensor 1 according to a first embodiment will be described with reference to the drawings.

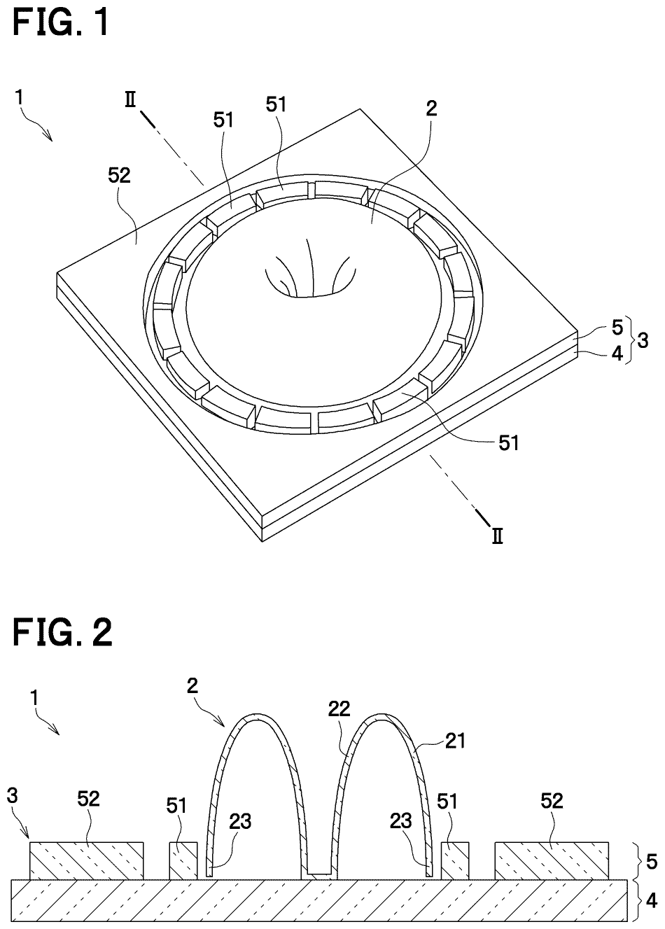

As illustrated in FIG. 1, for example, the gyro sensor 1 according to the present embodiment includes a resonator 2 and a mounting substrate 3, and includes a sensor element in which the resonator 2 is mounted on the mounting substrate 3. The gyro sensor 1 can detect an angular velocity and a rotation angle applied to the gyro sensor 1 on the basis of a change in electrostatic capacitance between a part of the thin resonator 2 capable of vibrating in a first vibration mode and a second vibration mode and a plurality of first electrode portions 51 of the mounting substrate 3. For example, the gyro sensor 1 is controlled in a whole angle mode by a control unit 10 to be described later, and correction and feedback processing for reducing an error of a measurement angle are executed.

For example, as illustrated in FIG. 2, the resonator 2 is a minute vibrating body having a three-dimensional substantially symmetrical structure including a curved surface 21 including an outer shape of a substantially hemispherical three-dimensional curved surface, and a mounting portion 22 extending from a vertex side of a virtual hemisphere formed by the curved surface 21 toward a center of the hemisphere. In the resonator 2, for example, conductive films (not illustrated) are formed on both a front surface and a back surface, and a voltage can be applied from the mounting substrate 3. In the resonator 2, for example, a rim 23 which is an end of the curved surface 21 on a side opposite to the mounting portion 22 faces the plurality of first electrode portions 51, and the rim 23 vibrates in a resonance mode due to an electrostatic force generated between the first electrode portion 51 and the rim 23.

Note that the resonator 2 can be manufactured, for example, by preparing a plate material including any reflow material such as quartz and a mold having a bowl-shaped recess and a support column located at a center of the recess, setting the plate material in the mold, and heating and softening the recess while decompressing the recess.

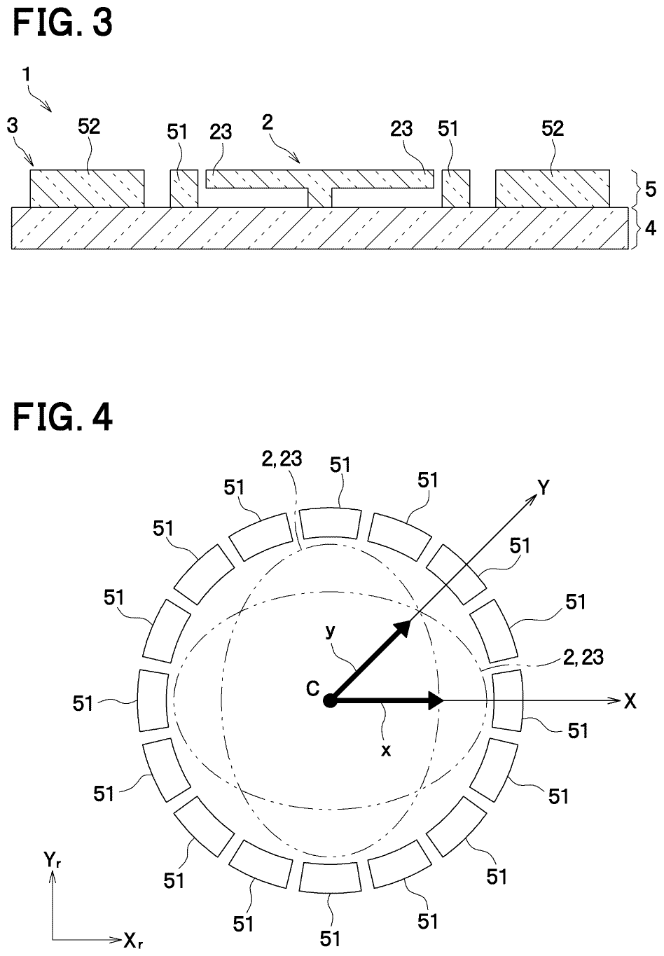

Alternatively, for example, as illustrated in FIG. 3, the resonator 2 may have a substantially disk shape having a disk-shaped portion and a columnar connection portion bonded to the mounting substrate 3 at a center of the disk-shaped portion. In this case, in the resonator 2, an end of a hollow disk-shaped portion is the rim 23, and the portion is surrounded by the plurality of first electrode portions 51. As described above, the resonator 2 only needs to have a structure capable of vibrating in the first vibration mode and the second vibration mode by a drive electrode among the plurality of first electrode portions 51, and may have another known structure other than the above structure.

For example, as illustrated in FIGS. 1 and 2, the mounting substrate 3 includes a lower substrate 4 and an upper substrate 5, and these substrates are bonded to each other. For example, the mounting substrate 3 is obtained by performing wiring film formation or the like on the lower substrate 4 including borosilicate glass as an insulating material, then anodically bonding the upper substrate 5 including silicon as a semiconductor material to the lower substrate 4, and performing patterning. In the mounting substrate 3, for example, dry etching such as DRIE is performed on the upper substrate 5 after anodic bonding to form the plurality of first electrode portions 51 and second electrode portions 52. The DRIE is an abbreviation for deep reactive ion etching. In the mounting substrate 3, for example, in a case where the resonator 2 has a bird bus shape illustrated in FIG. 2, an annular groove (not illustrated) along the rim 23 may be formed in the lower substrate 4 as necessary so as not to come into contact with the rim 23.

The plurality of first electrode portions 51 surrounds the rim 23 of the resonator 2, for example, and is arranged apart from each other at equal intervals so as to form one ring on a plane of the mounting substrate, and an electrode film (not illustrated) is formed on each top surface. The potential of the plurality of first electrode portions 51 can be controlled by, for example, connecting a wire (not illustrated) to the electrode film (not illustrated) and electrically connecting the electrode film to an external circuit board or the like. All of the plurality of first electrode portions 51 are separated from the rim 23 of the resonator 2 by a predetermined distance, each of the first electrode portions forms the resonator 2 and a capacitor, and electrostatic capacitance between the first electrode portions and the resonator 2 can be detected. Some of the plurality of first electrode portions 51 are detection electrodes that detect electrostatic capacitance, and the others are drive electrodes that apply electrostatic force to the rim 23 of the resonator 2.

For example, as illustrated in FIG. 1, the second electrode portion 52 has a single frame shape surrounding the plurality of first electrode portions 51, an electrode film (not illustrated) is formed on the top surface, and a wire (not illustrated) is connected to the electrode film (not illustrated). The second electrode portion 52 is connected to a conductive film (not illustrated) of the resonator 2 by wiring (not illustrated) or the like, and is configured to be capable of voltage application.

Hereinafter, for convenience of description, a sensor element including the resonator 2 and the mounting substrate 3 and a circuit (not illustrated) (such as a current-voltage conversion circuit, for example) used for applying a voltage to the plurality of first electrode portions 51 may be collectively referred to as a “sensor unit”.

When viewed from a normal direction with respect to a planar direction formed by the mounting substrate 3 (hereinafter referred to as “top view”), the resonator 2 is brought into a resonance state in which the number of antinodes and nodes in a vibration amplitude of the outline of the rim 23 is 2n as illustrated in FIG. 4, for example, by voltage application to some of the first electrode portions 51. The reference sign “n” is an integer of two or more, and such a resonance state of the resonator 2 is referred to as a “wineglass mode”. FIG. 4 illustrates, as a representative example, a state in which vibration axes x and y to be described later coincide with electrode axes X and Y in the resonance mode of n=2 in the wineglass mode, but the resonator 2 can be vibrated even in a high-order wineglass mode of n=3 or more.

Hereinafter, for convenience of description, as illustrated in FIG. 4, with a center position of the rim 23 in top view as a center C, a radial direction around a straight line passing through the center C along a thickness direction of the mounting substrate 3 is referred to as a “substrate radial direction”, and a circumferential direction around the straight line is referred to as a “substrate circumferential direction”. Of the directions along the substrate radial direction, a direction passing through the position of an antinode of vibration in the rim 23 of the resonator 2 in the first vibration mode (resonance angle frequency ω₁) is referred to as a “vibration axis x”, and a direction passing through the position of a node is referred to as a “vibration axis y”. In the wineglass mode with n=k (k: an integer of two or more), an angle between the vibration axis x and the vibration axis y is (360/4k)°. For example, in the wineglass mode with n=2, the angle between the vibration axis x and the vibration axis y is 45°.

For example, the plurality of first electrode portions 51 are arranged apart from each other along the substrate circumferential direction, and are arranged such that distances from the rim 23 in a non-vibrating state are substantially the same. For convenience, for example, as illustrated in FIG. 4, one direction on an actual plane on which the plurality of first electrode portions 51 is arranged is referred to as an “Xᵣ direction”, a direction orthogonal to the Xᵣ direction on the plane is referred to as a “Yᵣ direction”, and a plane to which the Xᵣ direction and the Yᵣ direction belong is referred to as an “XᵣYᵣ plane”. One direction in the XᵣYᵣ plane is defined as an “electrode axis X”, and a direction oriented when the electrode axis X is rotated counterclockwise (360/4k°) along the substrate circumferential direction on the XᵣYᵣ plane is defined as an “electrode axis Y”.

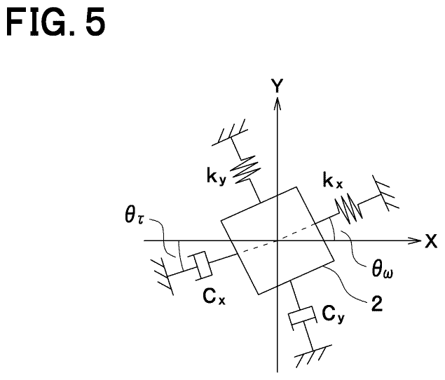

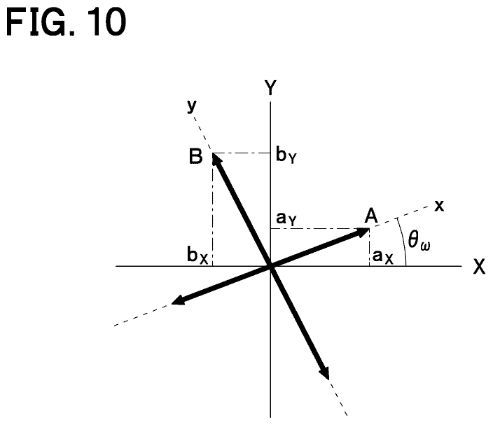

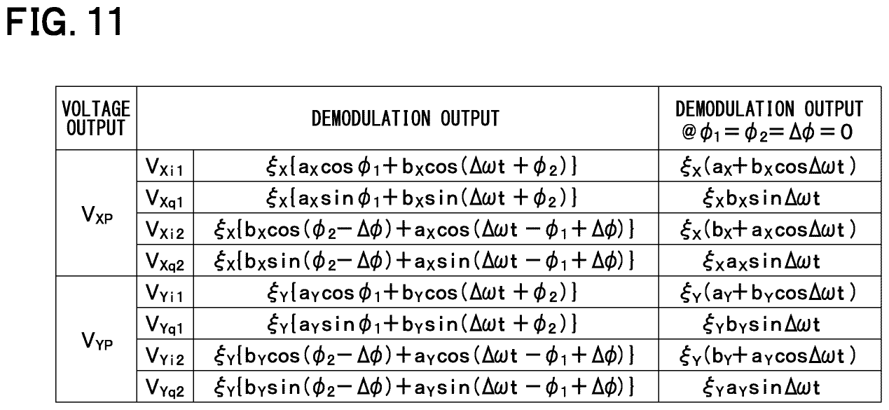

As illustrated in FIG. 5, for example, the sensor unit can be regarded as a vibrating body of a two-degree-of-freedom system in which two springs having spring constants kₓ and k_{y} along the vibration direction and two objects having damping coefficients Cₓ and C_{y} are connected and which vibrates on a two-dimensional plane in top view. FIGS. 5 and 10 to be described later illustrate that the vibration axes x and y and the electrode axes X and Y on the XᵣYᵣ plane are converted into an orthogonal coordinate system, and the origin of the vibration axes x and y and the origin of the electrode axes X and Y coincide with each other. The converted orthogonal coordinate system corresponds to a coordinate axis for calculation in the control unit 10. The vibration axes x and y can also be referred to as spring axes. Hereinafter, the vibration axes x and y may be simply referred to as an x axis and a y axis, respectively.

The spring constants kₓ and k_{y} are spring constants at the vibration axes x and y, respectively, and the damping coefficients Cₓ and C_{y} are damping coefficients of vibration at the vibration axes x and y, respectively. θ_{ω} is an angle formed by the electrode axes X and Y in the orthogonal coordinate system illustrated in FIG. 5 and the vibration axes x and y which are spring axes, that is, a deviation angle, and θᵣ is an angle formed by the electrode axes X and Y in the orthogonal coordinate system and a damping axis along a direction in which the vibration is attenuated. The sensor unit normally satisfies θ_{ω}≠0 unless special processing or the like is performed.

The above is a basic configuration of a sensor portion of the gyro sensor 1 according to the present embodiment. Details of the control unit 10 that executes the drive control of the gyro sensor 1 will be described next.

FIG. 1 illustrates, as a representative example, a case where the mounting substrate 3 has 16 first electrode portions 51 and one frame-shaped second electrode portion 52, but the present disclosure is not limited to this example. In the mounting substrate 3, for example, the number, arrangement, shape, and the like of the first electrode portion 51 and the second electrode portion 52 may be appropriately changed.

Next, the control unit 10 of the gyro sensor 1 will be described.

The control unit 10 is, for example, an electronic control unit in which various electronic components such as a CPU, a ROM, and a RAM are mounted on a circuit board (not illustrated) and which executes drive control in the gyro sensor 1. The CPU is an abbreviation for a central processing unit, the ROM is an abbreviation for read only memory, and the RAM is an abbreviation for random access memory.

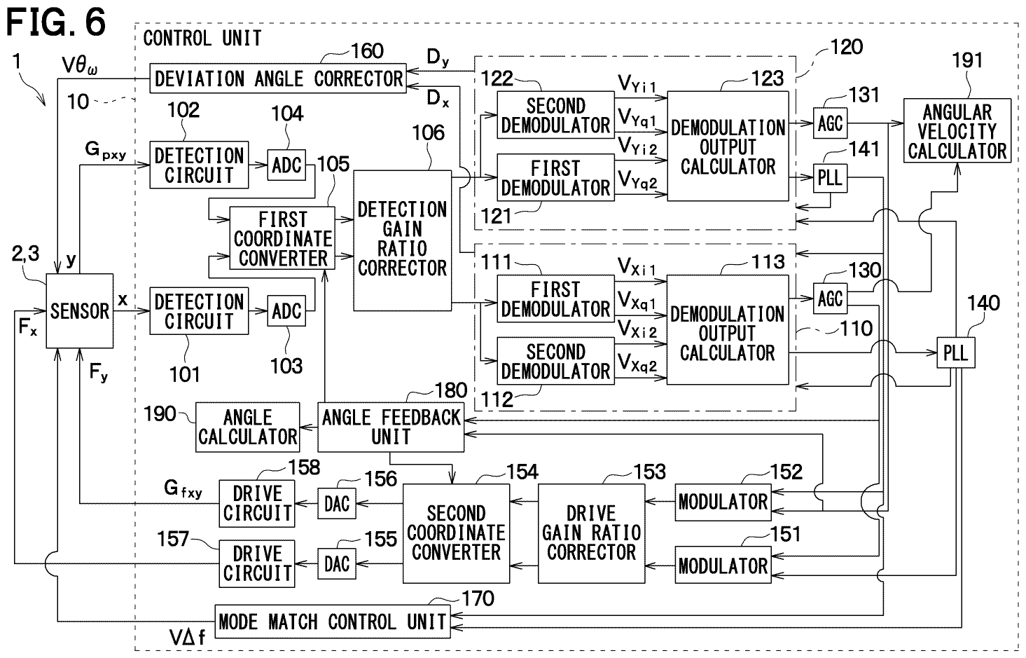

For example, as illustrated in FIG. 6, the control unit 10 includes detection circuits 101 and 102 that detect vibration of the x axis and the y axis of the resonator 2, and ADCs 103 and 104 that convert analog signals of the detection circuits 101 and 102 into digital signals. The ADC is an abbreviation for analog to digital converter. For example, the detection circuit 101 detects a signal from a detection electrode that detects vibration of the x axis among the plurality of first electrode portions 51. The detection circuit 102 detects a signal from a detection electrode that detects vibration of the vibration axis y among the plurality of first electrode portions 51. The ADC 103 converts an analog signal from the detection circuit 101 into a digital signal. The ADC 104 converts an analog signal from the detection circuit 102 into a digital signal.

The control unit 10 includes, for example, a first coordinate converter 105 to which signals from the ADCs 103 and 104 are input, a detection gain ratio corrector 106, a first demodulation block 110, and a second demodulation block 120.

For example, the first coordinate converter 105 performs a rotation matrix calculation for coordinate-converting input signals from the ADCs 103 and 104 into coordinate axes for calculation in which the electrode axes X and Y are orthogonal to each other and the vibration axes x and y are orthogonal to each other. Note that this rotation matrix calculation is a matrix calculation similar to the calculation of the equation (5) for converting the electrode axes X and Y into the vibration axes x and y to be described later. For example, the control unit 10 executes calculation processing in the first coordinate converter 105 to a second coordinate converter 154 on the converted coordinate axes. For example, the first coordinate converter 105 performs correction of the detection gain ratio G_{pxy}, feedback control of θ_{ω}, and feedback control of Δf in that order, and then performs feedback of a rotation angle θ from an angle feedback unit 180 to be described later. The rotation angle θ here refers to an azimuth formed by the current vibration direction of the resonator 2 on the vibration axes x and y of the coordinates after the conversion. G_{pxy} and calculation and the feedback control of the detection gain ratios θ_{ω} and Δf will be described later.

For example, the detection gain ratio corrector 106 corrects the gain ratio of the detection signals of the x axis and the y axis, that is, the detection gain ratio G_{pxy} on the basis of information from the demodulation blocks 110 and 120 when AGCs 130 and 131 and PLLs 140 and 141 are operated. The detection gain ratio G_{pxy} calculated by the detection gain ratio corrector 106 or a demodulation output calculator 113 is used for the feedback control of θ_{ω}.

For example, the first demodulation block 110 calculates a demodulation output related to the vibration axis x on the basis of the input signal from the detection gain ratio corrector 106. For example, on the basis of a frequency signal for the vibration axis x from the PLL 140 to be described later, the first demodulation block 110 outputs an amplitude component in phase with the frequency signal and an amplitude component having a phase deviated by 90° from the frequency signal. The first demodulation block 110 includes, for example, a first demodulator 111, a second demodulator 112, and a demodulation output calculator 113.

For example, the first demodulator 111 calculates demodulation outputs V_{Xi1} and V_{Xq1} on the basis of a first drive signal for driving the resonator 2 in the first vibration mode at the resonance angle frequency ω₁ and a detection signal V_{X} from the detection electrode of vibration of the first vibration mode. The demodulation outputs V_{Xi2} and V_{Xq2} are a demodulation output in phase with the first drive signal and a demodulation output in quadrature with the first drive signal, respectively. For example, the second demodulator 112 calculates demodulation outputs V_{Xi2} and V_{Xq2} on the basis of a second drive signal and the detection signal V_{X} for driving the resonator 2 in a second vibration mode at the resonance angle frequency ω₂. In the system in which the resonant drive of the resonance angle frequencies ω₁ and ω₂ of the resonator 2 is maintained by the two independent PLLs 140 and 141, this calculation is possible because the detection signal V_{X} includes information regarding a vibration amplitude in the direction of the vibration axis y of the second vibration mode. The demodulation outputs V_{Xi2} and V_{Xq2} are a demodulation output in phase with the second drive signal and a demodulation output in quadrature with the second drive signal, respectively. The demodulation output calculator 113 calculates an amplitude and a phase of the first vibration mode of the resonator 2 on the basis of V_{Xi1}, V_{Xq1}, V_{Xi2}, and V_{Xq2}, for example. Note that the first drive signal and the second drive signal correspond to a frequency signal for the vibration axis x and a frequency signal for the vibration axis y, respectively, and are input from the PLL 140 to the demodulation blocks 110 and 120.

For example, the second demodulation block 120 calculates a demodulation output related to the vibration axis y on the basis of the input signal from the detection gain ratio corrector 106. For example, on the basis of a frequency signal for the vibration axis y from the PLL 141 to be described later, the second demodulation block 120 outputs an amplitude component in phase with the frequency signal and an amplitude component having a phase deviated by 90° from the frequency signal. The second demodulation block 120 includes, for example, a first demodulator 121, a second demodulator 122, and a demodulation output calculator 123.

The first demodulator 121 calculates the demodulation outputs V_{Yi2} and V_{Yq2}, for example, on the basis of the second drive signal and a detection signal V_{Y} from the detection electrode of vibration in the second vibration mode. The demodulation outputs V_{Yi2} and V_{Yq2} are, for example, a demodulation output in phase with the second drive signal and a demodulation output in quadrature with the second drive signal, respectively. The second demodulator 122 calculates demodulation outputs V_{Yi1} and V_{Yq1}, for example, on the basis of the first drive signal and the detection signal V_{Y}. The demodulation by the second demodulator 122 is possible because the detection signal V_{Y} includes information regarding a vibration amplitude in the direction of the vibration axis x of the first vibration mode, as described above. The demodulation outputs V_{Yi1} and V_{Yq1} are, for example, a demodulation output in phase with the first drive signal and a demodulation output in quadrature with the first drive signal, respectively. The demodulation output calculator 113 calculates an amplitude and a phase of the second vibration mode of the resonator 2 on the basis of V_{Yi1}, V_{Yq1}, V_{Yi2}, and V_{Yq2}, for example. Note that the calculation of each demodulation output described above will be described later.

The control unit 10 includes the AGC 130 and the PLL 140 for control of resonantly driving the resonator 2 in the first vibration mode and maintaining the same, and the AGC 131 and the PLL 141 for resonantly driving the resonator 2 in the first vibration mode and the second vibration mode and maintaining the same in the resonance mode. The AGC is an abbreviation for automatic gain control, and is also referred to as control for automatic gain. The PLL is an abbreviation for phase locked loop.

For example, amplitude information in the direction of the vibration axis x of the first vibration mode of the resonator 2 is input from the first demodulation block 110, and the AGC 130 performs calculation and signal output for controlling the amplitude in the first vibration mode to a predetermined constant value on the basis of the amplitude information. For example, the AGC 130 outputs a control signal for amplitude fixation to a modulator 151, and outputs a signal for angular velocity calculation to an angular velocity calculator 191.

For example, amplitude information in the direction of the vibration axis y of the second vibration mode of the resonator 2 is input from the second demodulation block 120, and the AGC 131 performs calculation and signal output for controlling the amplitude in the second vibration mode to a predetermined constant value on the basis of the amplitude information. For example, the AGC 131 outputs a control signal for amplitude fixation to a modulator 152, and outputs a signal for angular velocity calculation to the angular velocity calculator 191.

For example, phase information regarding the first vibration mode of the resonator 2 is input from the first demodulation block 110 to the PLL 140, and the PLL 140 performs frequency control and signal output of the first drive signal for driving the resonator 2 in the first vibration mode of the resonance angle frequency ω₁. The PLL 140 includes, for example, a PI circuit and an NCO circuit (not illustrated). The PI circuit corrects a signal of the demodulation output V_{Xq1}, and the NCO circuit outputs the first drive signal having a predetermined frequency on the basis of the corrected signal. The PI is an abbreviation for proportional integral. The NCO is an abbreviation for numerically controlled oscillator, and generates a signal of a frequency such as a sin wave or a cos wave. The PLL 140 outputs a signal to the demodulation blocks 110 and 120 and the modulator 151.

For example, phase information regarding the second vibration mode of the resonator 2 is input from the second demodulation block 120 to the PLL 141, and the PLL 141 performs frequency control and signal output of the second drive signal for driving the resonator 2 the resonance angle frequency ω₂. The PLL 141 has a similar configuration to the configuration of the PLL 140. The PI circuit corrects a signal of the demodulation output V_{Yq2}, and the NCO circuit outputs the second drive signal having a predetermined frequency on the basis of the corrected signal. The PLL 141 outputs a signal to the demodulation blocks 110 and 120 and the modulator 152.

The control unit 10 includes, for example, the modulator 151 to which output signals from the AGC 130 and the PLL 140 are input, and the modulator 152 to which output signals from the AGC 131 and the PLL 141 are input. For example, the modulator 151 superimposes a frequency signal fₓ from the PLL 140 on an amplitude control signal input from the AGC 130, and outputs the superimposed signal to the drive gain ratio corrector 153. For example, the modulator 152 superimposes a frequency signal f_{y} from the PLL 141 on an amplitude signal input from the AGC 131, and outputs the superimposed signal to the drive gain ratio corrector 153.

The control unit 10 includes, for example, the drive gain ratio corrector 153, the second coordinate converter 154, DACs 155 and 156, and drive circuits 157 and 158.

The drive gain ratio corrector 153 calculates a gain ratio of the drive signals of the x axis and the y axis, that is, a drive gain ratio G_{fxy}, on the basis of the input signals from the modulators 151 and 152 when the AGCs 130 and 131 and the PLLs 140 and 141 are operated. After setting the detection gain ratio G_{pxy}, the drive gain ratio corrector 153 calculates the drive gain ratio G_{fxy} and outputs a signal corresponding to the calculation result to the second coordinate converter 154. The calculation of the drive gain ratio G_{fxy} will be described later.

The second coordinate converter 154 performs a rotation matrix calculation of converting the input signal from the drive gain ratio corrector 153 from converted coordinates converted by the first coordinate converter 105 into XᵣYᵣ coordinates illustrated in FIG. 4, that is, actual coordinates. In the second coordinate converter 154, for example, the rotation angle θ is fed back from the angle feedback unit 180 to be described later. For example, the second coordinate converter 154 outputs a signal corresponding to the calculated rotation angle of the x axis and y axis in a drive direction to the DACs 155 and 156. The drive gain ratio G_{fxy} and the calculation will be described later.

For example, the DACs 155 and 156 convert digital signals for drive control of the resonator 2 input from the second coordinate converter 154 into analog signals, and output the analog signals to the drive circuits 157 and 158, respectively. The DAC is an abbreviation for digital to analog converter.

For example, the drive circuits 157 and 158 generate analog drive signals for the x axis and the y axis output the analog drive signals to the drive electrodes of the plurality of first electrode portions 51 in order to vibrate the resonator 2 in the resonance mode on the basis of the output signals from the DACs 155 and 156. As a result, a force Fₓ by the electrostatic force and a force F_{y} by the electrostatic force respectively act on the x axis and the y axis on the resonator 2, and vibration control is performed.

The control unit 10 further includes, for example, a deviation angle corrector 160, a mode match control unit 170, the angle feedback unit 180, an angle calculator 190, and the angular velocity calculator 191.

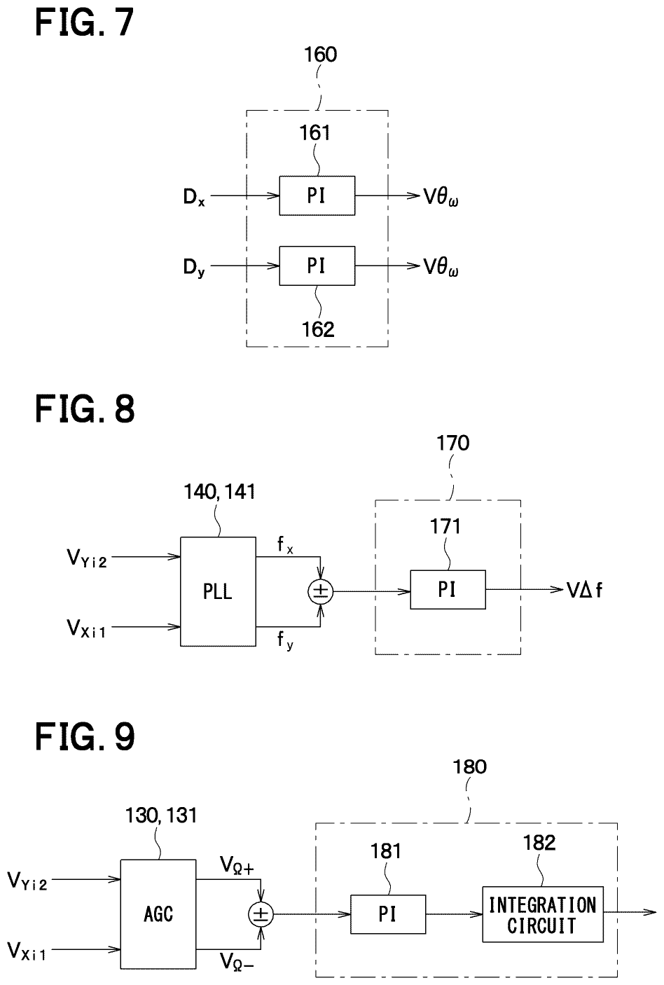

The deviation angle corrector 160 performs deviation angle correction for making θ_{ω} of an angle (hereinafter referred to as a “deviation angle”) formed by the vibration axes x and y and the electrode axes X and Y zero on the basis of any one of Dₓ or D_{y} calculated by the demodulation blocks 110 and 120, for example. For example, the deviation angle corrector 160 outputs a control signal Vθ_{ω} for controlling such that any one of Dₓ or D_{y} becomes zero to the sensor unit, and controls such that the vibration axes x and y and the electrode axes X and Y overlap each other, that is, θ_{ω}=0. For example, as illustrated in FIG. 7, the deviation angle corrector 160 includes two independent PIs 161 and 162. A signal corresponding to Dₓ from the first demodulation block 110 is input to the PI 161, and a signal corresponding to D_{y} from the second demodulation block 120 is input to the PI 162. Then, the deviation angle corrector 160 outputs, for example, the control signal Vθ_{ω} for performing control to satisfy Dₓ=0 or D_{y}=0 from one of the PI 161 or 162 to the sensor unit. The calculations of Dₓ and D_{y} will be described later.

For example, the mode match control unit 170 executes the mode match control such that the frequency difference Δf between the resonance angle frequency ω₁ of the first vibration mode and the resonance angle frequency ω₂ of the second vibration mode becomes zero after the feedback control of θ_{ω}=0 is performed by the deviation angle corrector 160. For example, as illustrated in FIG. 8, the mode match control unit 170 includes a PI 171, and a signal corresponding to the frequency difference Δf obtained on the basis of the frequency signals fₓ and f_{y} from the PLL 140 is input to the PI 171. The mode match control unit 170 outputs a control signal VΔf for controlling to satisfy the frequency difference Δf=0 to the sensor unit.

For example, after correcting the detection gain ratio G_{pxy}, the angle feedback unit 180 calculates the rotation angle θ by integrating the angular velocity on the basis of angular velocity information input from the AGCs 130 and 131. The angle feedback unit 180 outputs a signal corresponding to the rotation angle θ obtained by the calculation to the first coordinate converter 105 and the second coordinate converter 154. For example, as illustrated in FIG. 9, the angle feedback unit 180 includes a PI 181 to which the angular velocity information is input from the AGCs 130 and 131, and an integration circuit 182. The PI 181 corrects the angular velocity information obtained by subtraction calculation of the output signals V_{Ω+} and V_{Ω-} from the AGCs 130 and 131, and outputs the corrected signal to the integration circuit 182. The integration circuit 182 performs an integration calculation of the angular velocity on the basis of the corrected angular velocity information from the PI 181 and calculates an angle at which the angular velocity becomes zero (hereinafter referred to as “zero angle”). The integration circuit 182 outputs a signal corresponding to the calculated zero angle to the first coordinate converter 105 and the second coordinate converter 154.

The angle calculator 190 calculates the angle of the gyro sensor 1 on the basis of, for example, information of the zero angle from the angle feedback unit 180 and a scale factor measured in advance.

For example, on the basis of the input signals V_{Ω+} and V_{Ω-} from the AGCs 130 and 131, the angular velocity calculator 191 calculates the angular velocity applied from the outside to the gyro sensor 1 by dividing a value obtained by subtracting these signals by a scale factor measured in advance.

The basic configuration of the control unit 10 has been described above.

Next, calculation of the demodulation output in the demodulation blocks 110 and 120 will be described. Here, a case of n=2 in the wineglass mode will be described as a representative example, and a case of n=3 or higher is basically the same, and thus will not be described.

In a case where the first vibration mode and the second vibration mode of the resonance mode of n=2 are both driven to resonate, the resonator 2 vibrates along two orthogonal vibration axes x and y, for example, as illustrated in FIG. 10. The vibration amplitude and the resonance angle frequency on the vibration axis x are A and ω₁, respectively, the vibration amplitude and the resonance angle frequency on the vibration axis y are B and ω₂, respectively, and the angle between the vibration axis x and the electrode axis X is θ_{ω}. At this time, the vibration amplitudes of the vibration axes x and y at a time t are expressed by the following equations (2) and (3).

$$x = A sin ( {ω}_{1} t + {φ}_{1} ) \qquad ( 2 )$$

$$y = B sin ( {ω}_{2} t + {φ}_{2} ) \qquad ( 3 )$$

φ₁ in the equation (2) and φ₂ in the equation (3) are phases for an external force applied from each direction. Assuming that the respective components of the vibration of the amplitude A on the electrode axes X and Y are a_{X} and a_{Y}, and the respective components of the vibration of the amplitude B on the electrode axes X and Y are b_{X} and b_{Y}, the deviation angle θ_{ω} between the vibration axis x and the electrode axis X, is expressed by the following equation (4) from the orthogonality of the vibration axes x and v.

$$\vert \frac{{a}_{X}}{{a}_{Y}} \vert = \vert \frac{{b}_{X}}{{b}_{Y}} \vert = tan ( \vert {θ}_{ω} \vert ) \qquad ( 4 )$$

The conversion between the electrode axes X and Y and the vibration axes x and y is expressed by the following equation (5).

$$( \begin{matrix}X \\ Y\end{matrix} ) = ( \begin{matrix}cos {θ}_{ω} & sin {θ}_{ω} \\ - sin {θ}_{ω} & cos {θ}_{ω}\end{matrix} ) ( \begin{matrix}x \\ y\end{matrix} ) \qquad ( 5 )$$

Since the electrode axis X is a sum of X components of the two vibration modes and the electrode axis Y is a sum of Y components of the two vibration modes, the vibration amplitudes of the electrode axes X and Y at the time t are expressed by the following equations (6) and (7).

$$X = {a}_{X} sin ( {ω}_{1} t + {φ}_{1} ) + {b}_{X} sin ( {ω}_{2} t + {φ}_{2} ) \qquad ( 6 )$$

$$Y = {a}_{Y} sin ( {ω}_{1} t + {φ}_{1} ) + {b}_{Y} sin ( {ω}_{2} t + {φ}_{2} ) \qquad ( 7 )$$

Note that the components a_{X}, b_{X}, a_{Y}, and b_{Y} in the equations (6) and (7) are a_{X}=A cos θ_{ω}, b_{X}=−B sin θ_{ω}, a_{Y}=A sin θ_{ω}, and b_{Y}=B cos θ_{ω}, respectively, in the example illustrated in FIG. 7. In addition, assuming that conversion coefficients from the amplitude to the voltage according to a detection method are ζ_{X} and ζ_{Y}, the voltages V_{XP} and V_{YP} at the detection electrodes of the electrode axes X and Y are expressed by the following equations (8) and (9).

$${V}_{XP} = {ξ}_{X} \{ {a}_{X} sin ( {ω}_{1} t + {φ}_{1} ) + {b}_{X} sin ( {ω}_{2} t + {φ}_{2} ) \} \qquad ( 8 )$$

$${V}_{YP} = {ξ}_{Y} \{ {a}_{Y} sin ( {ω}_{1} t + {φ}_{1} ) + {b}_{Y} sin ( {ω}_{2} t + {φ}_{2} ) \} \qquad ( 9 )$$

The first demodulator 111 calculates the demodulation outputs V_{Xi1} and V_{Xq1} for the external force on the vibration axes x and y on the basis of the voltage V_{XP} of the equation (8). The demodulation output V_{Xi1} is calculated by performing processing of multiplying the voltage V_{XP} by sin ω₁t as expressed by the following equation (10) and passing through a low-pass filter as expressed by the equation (11) to eliminate the term of a second harmonic and a frequency sum.

$$\begin{matrix}{V}_{XP} sin {ω}_{1} t = {ξ}_{X} \{ {a}_{X} sin ( {ω}_{1} t + {ϕ}_{1} ) + {b}_{X} sin ( {ω}_{2} t + {ϕ}_{2} ) \} sin {ω}_{1} t \\ = \frac{{ξ}_{X}}{2} \{ {a}_{X} cos ϕ ( 1 - cos 2 {ω}_{1} t ) + {a}_{X} sin {ϕ}_{1} sin 2 {ω}_{1} t + \\ {b}_{X} cos {ϕ}_{2} ( - cos ( {ω}_{1} + {ω}_{2} ) t + cos Δ ω t ) + \\ {b}_{X} sin {ϕ}_{2} ( sin ( {ω}_{1} + {ω}_{2} ) t - sin Δ ω t ) \}\end{matrix} \qquad ( 10 )$$

$$\begin{matrix}{V}_{X i 1} = {\vert 2 {V}_{XP} sin {ω}_{1} t \vert}_{LPF} \\ = {ξ}_{X} \{ {a}_{X} cos {ϕ}_{1} + {b}_{X} ( cos {ϕ}_{2} cos Δ ω t - sin {ϕ}_{2} sin Δ ω t ) \} \\ = {ξ}_{X} \{ {a}_{X} cos {ϕ}_{1} + {b}_{X} cos ( Δ ω t + {ϕ}_{2} ) \}\end{matrix} \qquad ( 11 )$$

|f(t)|_{LPF} in the equation (11) means a calculation for erasing a term of a second harmonic and a frequency sum passing through the low-pass filter. The same applies to the following equations (13), (15), and (17).

The demodulation output V_{Xq1} is calculated by performing processing of multiplying the voltage V_{XP} by cos ω₁t as expressed by the following equation (12) and performing calculation of erasing unnecessary terms through the low-pass filter as expressed by the equation (13).

$$\begin{matrix}{V}_{XP} cos {ω}_{1} t = {ξ}_{X} \{ {a}_{X} sin ( {ω}_{1} t + {ϕ}_{1} ) + {b}_{X} sin ( {ω}_{2} t + {ϕ}_{2} ) \} cos {ω}_{1} t \\ = \frac{{ξ}_{X}}{2} \{ {a}_{X} cos {ϕ}_{1} sin 2 {ω}_{1} t + {a}_{X} sin {ϕ}_{1} ( 1 + cos 2 {ω}_{1} t ) + \\ {b}_{X} cos {ϕ}_{2} ( sin ( {ω}_{1} + {ω}_{2} ) t + sin Δω t ) + \\ {b}_{X} sin {ϕ}_{2} ( cos ( {ω}_{1} + {ω}_{2} ) t + cos Δ ω t ) \}\end{matrix} \qquad ( 12 )$$

$$\begin{matrix}{V}_{Xq 1} = {\vert 2 {V}_{XP} cos {ω}_{1} t \vert}_{LPF} \\ = {ξ}_{X} \{ {a}_{X} sin {ϕ}_{1} + {b}_{X} ( cos {ϕ}_{2} sin Δ ω t + sin {ϕ}_{2} cos Δ ω t ) \} \\ = {ξ}_{X} \{ {a}_{X} sin {ϕ}_{1} + {b}_{X} sin ( Δ ω t + {ϕ}_{2} ) \}\end{matrix} \qquad ( 13 )$$

The second demodulator 112 calculates the demodulation outputs V_{Xi2} and V_{Xq2} for the external force on the vibration axes x and y on the basis of the voltage V_{XP} of the equation (8). The second demodulator 112 acquires a frequency signal for driving the resonator 2 at the resonance angle frequency ω₂ from the PLL 141, for example, and calculates the demodulation outputs V_{Xi2} and V_{Xq2}. The demodulation output V_{Xi2} is calculated by performing processing of multiplying the voltage V_{XP} by sin (ω₂t+Δφ) as expressed by the following equation (14) and performing calculation of erasing unnecessary terms through the low-pass filter as expressed by the equation (15). Note that Δφ is a phase of an output signal of the oscillation circuit (not illustrated) in the PLLs 140 and 141 when the output signal of the oscillation circuit (not illustrated) in the PLLs 140 and 141 is used as a reference.

$${V}_{XP} sin ( ω 2 t + Δφ ) = {ξ}_{X} \{ {a}_{X} sin ( {ω}_{1} t + {φ}_{1} ) + {b}_{X} sin ( {ω}_{2} t + {φ}_{2} ) \} sin ( {ω}_{2} t + Δφ ) \qquad ( 14 )$$

$$\begin{matrix}{V}_{Xi 2} = {\vert 2 {V}_{XP} sin ( {ω}_{2} t + Δϕ ) \vert}_{LPF} \\ = {ξ}_{X} \{ {b}_{X} cos ( {ϕ}_{2} - Δ ϕ ) + {a}_{X} cos ( Δ ω t - {ϕ}_{1} + Δ ϕ ) \}\end{matrix} \qquad ( 15 )$$

The demodulation output V_{Xq2} is calculated by performing processing of multiplying the voltage V_{XP} by cos (ω₂t+Δφ) as expressed by the following equation (16) and performing calculation of erasing unnecessary terms through the low-pass filter as expressed by the equation (17).

$${V}_{XP} cos ( ω 2 t + Δφ ) = {ξ}_{X} \{ {a}_{X} sin ( {ω}_{1} t + {φ}_{1} ) + {b}_{X} sin ( {ω}_{2} t + {φ}_{2} ) \} cos ( {ω}_{2} t + Δφ ) \qquad ( 16 )$$

$$\begin{matrix}{V}_{Zq 2} = {\vert 2 {V}_{XP} cos ( {ω}_{2} t + Δϕ ) \vert}_{LPF} \\ = {ξ}_{X} \{ {b}_{X} sin ( {ϕ}_{2} - Δ ϕ ) + {a}_{X} sin ( Δ ω t - {ϕ}_{1} + Δ ϕ ) \}\end{matrix} \qquad ( 17 )$$

The first demodulator 121 calculates the demodulation outputs V_{Yi2} and V_{Yq2} for the external force on the vibration axes x and y on the basis of the detection voltage V_{YP} of the equation (9). The second demodulator 122 acquires a frequency signal for driving the resonator 2 at the resonance angle frequency ω₁ from the PLL 140, for example, and calculates the demodulation outputs V_{Yi1} and V_{Yq1}. The demodulation outputs V_{Yi1}, V_{Yq1}, V_{Yi2}, and V_{Yq2} based on the detection voltage V_{YP} are calculated by calculation processing similar to V_{Xi1}, V_{Xq1}, V_{Xi2}, and V_{Xq2} described above, and are expressed by the equations illustrated in FIG. 8. In a case where φ₁=φ₂=Δφ=0 is satisfied, these demodulation outputs can be transformed into mathematical expressions without terms of φ₁, φ₂, and Δφ.

The demodulation outputs V_{Xi1}, V_{Xq1}, V_{Xi2}, V_{Xq2}, V_{Yi1}, V_{Yq1}, V_{Yi2}, and V_{Yq2} are output to, for example, the demodulation output calculators 113 and 123 and the like and are used for calculating the amplitudes and the phase differences of the first vibration mode and the second vibration mode. Hereinafter, for convenience of description, the demodulation outputs V_{Xi1}, V_{Xq1}, V_{Xi2}, V_{Xq2}, V_{Yi1}, V_{Yq1}, V_{Yi2}, and V_{Yq2} are collectively referred to as “each of the demodulation outputs”.

Next, calculation of the amplitude and phase of the vibration mode using each demodulation output will be described.

For example, the demodulation output calculators 113 and 123 include a high-pass filter (hereinafter referred to as “HPF”), a calculator that performs calculation using each of the demodulation outputs after passing through the HPF, and a phase comparison unit that calculates a phase difference of each of the demodulation outputs.

For example, the demodulation output calculator 113 calculates |ζ_{X}b_{X}| by calculating a sum of squares by adding the results obtained by squaring the demodulation outputs V_{Xi1} and V_{Xq1} after passing through the HPF by the calculator. For example, the demodulation output calculator 113 calculates |ζ_{X}a_{X}| by calculating a sum of squares in the calculator based on the demodulation outputs V_{Xi2} and V_{Xq2} after passing through the HPF. In addition, the demodulation output calculator 113 calculates a phase difference Δφ_{Xi} on the basis of the demodulation outputs V_{Xi1} and V_{Xi2} after passing through the HPF, and calculates a phase difference Δφ_{Xq} on the basis of the demodulation outputs V_{Xq1} and V_{Xq2} after passing through the HPF, for example.

For example, the demodulation output calculator 123 calculates |ζ_{Y}b_{Y}| by the calculation of a sum of squares based on the demodulation outputs V_{Yi1} and V_{Yq1} and calculates |ζ_{Y}a_{Y}| by the calculation of a sum of squares based on the demodulation outputs V_{Yi2} and V_{Yq2} by similar processing to the processing of the demodulation output calculator 113. For example, similarly to the demodulation output calculator 113, the demodulation output calculator 123 calculates a phase difference Δφ_{Yi} on the basis of the demodulation outputs V_{Yi1} and V_{Yi2}, and calculates a phase difference Δφ_{Yq} on the basis of V_{Yq1} and V_{Yq2}.

For example, the demodulation blocks 110 and 120 can acquire the amplitude information of the resonance mode by the above calculation of |ζ_{X}a_{X}|, |ζ_{Y}a_{Y}|, |ζ_{X}b_{X}|, and |ζ_{Y}b_{Y}|, and can acquire the phase information of the resonance mode by the above calculation of the phase differences Δφ_{Xi}, Δφ_{Xq}, Δφ_{Yi}, and Δφ_{Yq}.

Hereinafter, for convenience of description, the calculation of |ζ_{X}a_{X}|, |ζ_{Y}a_{Y}|, |ζ_{X}b_{X}|, and |ζ_{Y}b_{Y}| for calculating the amplitude are simply referred to as “amplitude calculation”. The demodulation outputs V_{Xi1} and V_{Xq1} calculated by the first demodulator 111 may be referred to as “first demodulation outputs”, and the demodulation outputs V_{Yi2} and V_{Yq2} calculated by the first demodulator 121 may be referred to as “second demodulation outputs”. The demodulation outputs V_{Xi2} and V_{Xq2} calculated by the second demodulator 112 may be referred to as “third demodulation outputs”, and the demodulation outputs V_{Yi1} and V_{Yq1} calculated by the second demodulator 122 may be referred to as “fourth demodulation outputs”.

Next, the calculation of θ_{ω} by the deviation angle corrector 160 and the feedback control of θ_{ω} will be described.

In the control unit 10, the first demodulation output calculator 113 performs calculation based on the first demodulation output and the third demodulation output, and the second demodulation output calculator 123 performs calculation based on the second demodulation output and the fourth demodulation output.

Here, the angle θ_{ω} formed by the vibration axes x and y and the electrode axes X and Y, that is, the deviation angle θ_{ω} can be calculated by the following equation (18) or (19).

$$\vert {θ}_{ω} \vert = {tan}^{- 1} ( \vert \frac{{ξ}_{Y} {a}_{Y}}{{ξ}_{X} {a}_{X}} \vert \sqrt{\frac{{D}_{x}}{{D}_{y}}} ) \qquad ( 18 )$$

$$\vert {θ}_{ω} \vert = {tan}^{- 1} ( \vert \frac{{ξ}_{X} {b}_{X}}{{ξ}_{Y} {b}_{Y}} \vert \sqrt{\frac{{D}_{y}}{{D}_{x}}} ) \qquad ( 19 )$$

When D_{X} and D_{Y} in the equations (18) and (19) are collectively denoted by Dₖ, Dₖ is expressed by the following equation (20).

$${D}_{k} = \vert {ξ}_{k}^{2} {a}_{k} {b}_{k} \vert ( k = X , Y ) \qquad ( 20 )$$

On the basis of the demodulation output calculated by the demodulators 111, 112, 121, and 122, the control unit 10 applies the control voltage from the deviation angle corrector 160 to the sensor unit such that |θ_{ω}|=0 expressed by the equation (18) or (19). |θ_{ω}|=0 is obtained when D_{X}=0 or D_{Y}=0 is satisfied from the equations (18) and (19).

For example, the first demodulation output calculator 113 calculates the value of |ζ_{X}b_{X}| by performing the calculation of a sum of squares obtained by squaring each of the demodulation outputs V_{Xi1} and V_{Xq1} in φ₁=φ₂=Δφ=0. For example, the second demodulation output calculator 123 calculates the value of |ζ_{Y}b_{Y}| by performing the calculation of a sum of squares obtained by squaring each of the demodulation outputs V_{Yi2} and V_{Yq2} in φ₁=φ₂=Δφ=0. These calculation results are output to the control circuit 150, for example, and are used for feedback control in which D_{X}=0 or D_{Y}=0, that is, |θ_{ω}|=0.

In the feedback control of |θ_{ω}|=0, for example, the deviation angle corrector 160 determines whether to rotate the vibration axes x and y clockwise or counterclockwise on the basis of the calculation of the phase information by the demodulation blocks 110 and 120. As illustrated in FIG. 12, for example, the deviation angle corrector 160 determines whether the output waveforms of the demodulation outputs V_{Xi} and V_{Xq} and the output waveforms of the demodulation outputs V_{Yi} and V_{Yq} are in phase or in reverse phase on the basis of the calculated phase difference. The polarity “+” of θ_{ω} in FIG. 12 means a case where the vibration axis is deviated counterclockwise with respect to the electrode axis, and the polarity “−” of θ_{ω} means a case where the vibration axis is deviated clockwise with respect to the electrode axis. The deviation angle corrector 160 determines the rotation direction of the vibration axis in a direction opposite to the deviation direction in accordance with the polarity of θ_{ω}, and outputs the determined control signal Vθ_{ω} to some of the first electrode portions 51.

Next, the detection gain ratio and the calculation of the detection gain ratio will be described.

In the system in which a driving force is input to the resonator 2 as illustrated in FIG. 6, for example, a case where a non-ideal gain ratio between the x axis and the y axis exists as the detection gain ratio G_{pxy} will be considered. In this case, assuming that voltages input to the axes are voltages Vₓ and V_{y}, x and y of vibration information of the resonator 2 are expressed by the following equation (21) by the voltages Vₓ and V_{y} and the detection gain ratio G_{pxy}.

$$[ \begin{matrix}{X}_{x} \\ {V}_{y}\end{matrix} ] = [ \begin{matrix}1 & 0 \\ 0 & {G}_{pxy}\end{matrix} ] [ \begin{matrix}x \\ y\end{matrix} ] = [ \begin{matrix}x \\ {G}_{pxy} \cdot y\end{matrix} ] \qquad ( 21 )$$

In order to cancel the non-ideal detection gain ratio G_{pxy} in the equation (21), the detection gain ratio G_{pxy} only needs to be calculated by some means, and the equation (21) only needs to be multiplied by a determinant of the following equation (22).

$$[ \begin{matrix}1 & 0 \\ 0 & 1 / {G}_{pxy}\end{matrix} ] \qquad ( 22 )$$

For example, the detection gain ratio corrector 106 performs a matrix calculation of multiplying the determinant of the equation (22), that is, a matrix including 1/G_{pxy} that is a reciprocal of the detection gain ratio by the determinant of the detection signal obtained through the detection circuits 101 and 102 indicated in the equation (21). When calculating the detection gain ratio and the drive gain ratio, the control unit 10 performs gain ratio calculation processing in a state where the rotation angle is not fed back, that is, in an off-line state. In the calculation mode of each gain ratio, the control unit 10 inputs detection signals of vibration in the x and y axes from the sensor unit to the demodulation blocks 110 and 120 through the detection circuits 101 and 102 and the ADCs 103 and 104, and performs each of the demodulation outputs and amplitude calculation based on each of the demodulation outputs. The demodulation outputs V_{Xq1} and V_{Yq2} are used for calculating the detection gain ratio G_{pxy}. The detection gain ratio G_{pxy} calculated in a gain ratio calculation mode is, for example, held in a recording medium (not illustrated) in the control unit 10, and then read from the recording medium and used in an angular velocity and angle calculation mode for calculating an angular velocity and an angle. The same applies to the drive gain ratio G_{fxy} to be described later.

The calculation of the detection gain ratio G_{pxy} is performed in a state where no angular velocity input is applied to the sensor unit, that is, in the off-line state. The detection gain ratio G_{pxy} is expressed by the following equation (23).

$${G}_{pxy} = \frac{{k}_{x}}{{k}_{y}} = \sqrt{\frac{{D}_{x}}{{D}_{y}}} \qquad ( 23 )$$

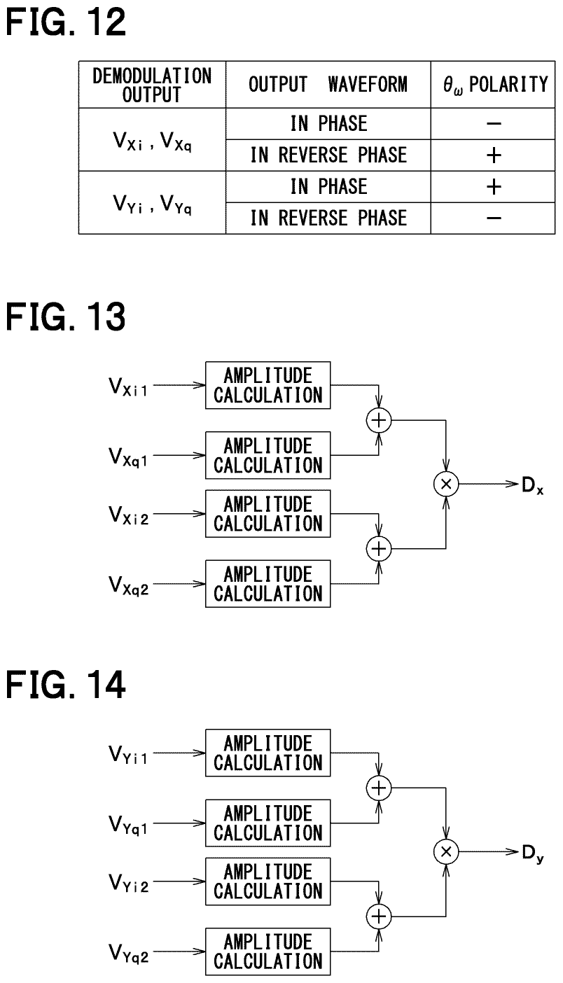

Dₓ and D_{y} in the equation (23) are calculated by the calculations illustrated in FIGS. 13 and 14, for example. Specifically, for example, as illustrated in FIG. 13, the first demodulation block 110 performs an amplitude calculation based on the demodulation output V_{Xi} and an amplitude calculation based on the demodulation output V_{Xq1}, and calculates a first addition value obtained by adding two values obtained by each of the amplitude calculations. In addition, for example, the first demodulation block 110 performs an amplitude calculation based on the demodulation output V_{Xi2} and an amplitude calculation based on the demodulation output V_{Xq2}, and calculates a second addition value obtained by adding two values obtained by each of the amplitude calculations. Then, for example, the first demodulation block 110 calculates the calculation value Dₓ by multiplying the first addition value by the second addition value.

For example, as illustrated in FIG. 14, the second demodulation block 120 performs an amplitude calculation on the basis of each of the demodulation outputs V_{Yi1} and V_{Yq1}, and adds the obtained two values to calculate a third addition value. Furthermore, for example, the second demodulation block 120 performs an amplitude calculation based on each of the demodulation outputs V_{Yi2} and V_{Yq2}, calculates a fourth addition value obtained by adding two values obtained by each of the amplitude calculations, and then multiplies the fourth addition value by the third addition value and the fourth addition value to calculate the calculation value D_{y}.

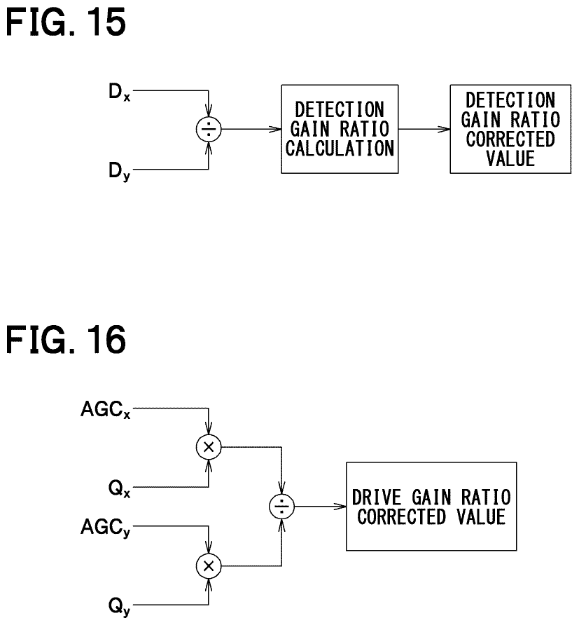

Then, for example, as illustrated in FIG. 15, the detection gain ratio corrector 106 performs calculation to obtain a square root of a value obtained by dividing the calculated Dₓ by D_{y}, and calculates the detection gain ratio G_{pxy}. Then, the detection gain ratio corrector 106 calculates a detection gain ratio correction value expressed by the equation (22) on the basis of the detection gain ratio G_{pxy}, and multiplies the equation (21) by the detection gain ratio correction value to correct the detection gain ratio.

Next, a case where a non-ideal gain ratio between the driving force Fₓ and the driving force F_{y} exists as the drive gain ratio G_{fxy} in a system in which the driving forces Fₓ and F_{y} are input to the resonator 2 will be considered. Assuming that the output signal from the DAC 155 of the x axis and the output signal from the DAC 156 of the y axis are VFₓ and VF_{y}, respectively, the driving forces Fₓ and F_{y} applied to the resonator 2 on the basis of the drive signals from the drive circuits 157 and 158 are expressed by the following equation (24) including the drive gain ratio G_{fxy}.

$$[ \begin{matrix}{F}_{x} \\ {F}_{y}\end{matrix} ] = [ \begin{matrix}1 & 0 \\ 0 & {G}_{fxy}\end{matrix} ] [ \begin{matrix}{VF}_{x} \\ {VF}_{y}\end{matrix} ] = [ \begin{matrix}{VF}_{x} \\ {G}_{fxy} \cdot {VF}_{y}\end{matrix} ] \qquad ( 24 )$$

In order to cancel the non-ideal drive gain ratio G_{fxy} in the equation (24), the drive gain ratio G_{fxy} only needs to be calculated by some means, and the equation (24) only needs to be multiplied by a determinant of the following equation (25).

$$[ \begin{matrix}1 & 0 \\ 0 & 1 / {G}_{fxy}\end{matrix} ] \qquad ( 25 )$$

For example, the drive gain ratio corrector 153 performs a matrix calculation of multiplying the determinant of the equation (25), that is, a matrix including 1/G_{fxy} that is a reciprocal of the drive gain ratio by the determinant of the equation (24). The calculation of the drive gain ratio G_{fxy} is performed in the off-line state similarly to the calculation of the detection gain ratio G_{pxy}. The drive gain ratio G_{fxy} is expressed by the following equation (26).

$${G}_{fxy} = \frac{{F}_{x} {Q}_{x}}{{F}_{y} {Q}_{y}} \qquad ( 26 )$$

For example, as illustrated in FIG. 16, the drive gain ratio corrector 153 calculates the drive gain ratio G_{fxy} and a drive gain ratio correction value on the basis of AGCₓ, Qₓ, AGC_{y}, and Q_{y}. AGCₓ is an AGC output regarding the driving force Fₓ of the x axis output from the AGC 130 to the modulator 151, and AGC_{y} is an AGC output regarding the driving force F_{y} of the y axis output from the AGC 131 to the modulator 152. Qₓ and Q_{y} are a Q value of vibration on the x axis of the resonator 2 and a Q value of vibration on the y axis of the resonator 2, respectively, and are calculated in advance by a known method for measuring a Q value and recorded in a recording medium (not illustrated). The drive gain ratio corrector 153 calculates a first multiplication value obtained by multiplication of AGCₓ and Qₓ and a second multiplication value obtained by multiplication of AGC_{y} and Q_{y}, and calculates the drive gain ratio G_{fxy} by dividing the first multiplication value by the second multiplication value. Then, the drive gain ratio corrector 153 calculates a drive gain ratio correction value expressed by the equation (25) on the basis of the drive gain ratio G_{fxy}, and multiplies the equation (24) by the drive gain ratio correction value to correct the drive gain ratio.

Next, a processing operation example of error reduction in measurement of the angle or the angular velocity in the gyro sensor 1 will be described.

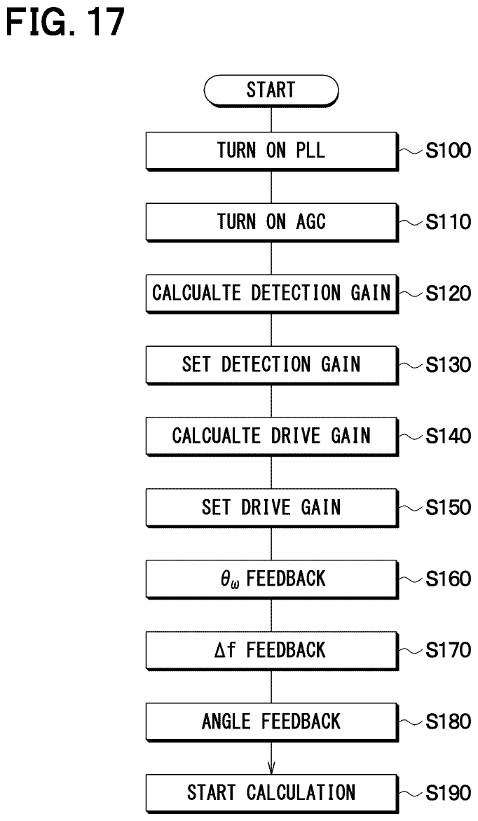

The control unit 10 starts a control flow illustrated in FIG. 17 when a predetermined start condition is satisfied, for example, when an external power supply for driving the gyro sensor 1 is turned on.

In step S100, the control unit 10 turns on the PLLs 140 and 141, for example, and starts the frequency control of the first and second drive signals in order to vibrate the resonator 2 in the first vibration mode and the second vibration mode.

In step S110, the control unit 10 turns on the AGCs 130 and 131, for example, and starts control of the amplitude in vibration in the first vibration mode and the second vibration mode of the resonator 2. As a result, the resonator 2 is maintained in two vibration states including a vibration mode of the resonance angle frequency ω₁ and a predetermined amplitude A and a vibration mode of the resonance angle frequency ω₂ and a predetermined amplitude B.

In step S120, the control unit 10 acquires detection signals from each of a first detection electrode that detects vibration on the x axis and a second detection electrode that detects vibration on the y axis among the plurality of first electrode portions 51. Then, the detection gain ratio corrector 106 executes calculation of the detection gain ratio G_{pxy}, that is, identification by the calculation described above.

In step S130, for example, the detection gain ratio corrector 106 sets the detection gain ratio, that is, corrects the detection gain ratio by the matrix calculation of multiplying the matrix including the reciprocal 1/G_{pxy} of the calculated detection gain ratio. As a result, an influence of a measurement error in the gyro sensor 1 due to a gain ratio of the detection signal between the x axis and the y axis is reduced. The control unit 10 executes the processing of steps S120 and S130 in a state where the rotation angle feedback by the angle feedback unit 180 is turned off or in a state where the gain of the output signal of the PI 181 is set to zero, that is, in the off-line state.

In step S140, for example, the drive gain ratio corrector 153 calculates the drive gain ratio G_{fxy} by the calculation described above, that is, executes identification on the basis of the drive signal for the first vibration mode on the x axis and the drive signal for the second vibration mode on the y axis.

In step S150, for example, the drive gain ratio corrector 153 sets the drive gain ratio, that is, corrects the drive gain ratio by the matrix calculation of multiplying the matrix including the reciprocal 1/G_{fxy} of the calculated drive gain ratio. As a result, an influence of a measurement error in the gyro sensor 1 due to a gain ratio of the drive signal between the x axis and the y axis is reduced.

In step S160, for example, the deviation angle corrector 160 outputs the control signal Vθ_{ω} to the sensor unit such that one of the calculation value Dₓ or D_{y} calculated by the demodulation blocks 110 and 120 becomes zero. As a result, the resonator 2 is controlled such that the vibration axes x and y substantially coincide with the electrode axes X and Y. Since it is necessary to minimize θ_{ω} in order to execute Δf feedback control, the θ_{ω} control is executed before the feedback control of Δf.

In step S170, for example, the mode match control unit 170 outputs the control signal VΔf to the sensor unit on the basis of the output signals from the PLLs 140 and 141 such that the frequency difference Δf between the resonance angle frequency ω₁ of the first vibration mode and the resonance angle frequency ω₂ of the second vibration mode becomes zero. As a result, in the resonator 2, for example, an electric spring effect is generated by an electrostatic force between the rim 23 and some of the plurality of first electrode portions 51, and one or both of the high resonance angle frequencies ω₁ and ω₂ of the first and second vibration modes are controlled to satisfy Δf=0.

In step S180, the control unit 10 turns on the angle feedback unit 180, drives the PI 181 and the integration circuit 182 on the basis of the input signals from the AGCs 130 and 131, and calculates the rotation angle of the gyro sensor 1. Then, the angle feedback unit 180 outputs a signal corresponding to the calculated rotation angle to the first coordinate converter 105 and the second coordinate converter 154, and executes feedback of the rotation angle.

Finally, in step S190, the control unit 10 executes the calculation of the angular velocity and the angle applied to the gyro sensor 1 by the angle calculator 190 and the angular velocity calculator 191. As a result, in the gyro sensor 1, the influence of the detection gain ratio G_{pxy} and the drive gain ratio G_{fxy} is reduced, the Δf feedback control is performed after the θ_{ω} control, the accuracy of the Δf feedback is improved, and thus the error of the measurement angle is reduced.

An example of processing of reducing the error of the measurement angle in the gyro sensor 1 has been described above. In this measurement angle error reduction processing, at least three processings of correction of the detection gain ratio G_{pxy}, the θ_{ω} control, and the Δf feedback control only need to be executed in that order, and the drive gain ratio G_{fxy} only needs to be corrected after the correction of the detection gain ratio G_{pxy}. Therefore, the correction of the drive gain ratio G_{fxy} may be performed between the θ_{ω} control and the Δf feedback control or after the Δf feedback control. That is, in the correction of the gain ratio of the detection signal and the gain ratio of the drive signal, that is, gain mismatch correction, the processing immediately after the correction of the detection gain ratio G_{pxy} may be the correction of the drive gain ratio G_{fxy}, or the correction of the drive gain ratio G_{fxy} may be executed between the correction of the detection gain ratio G_{pxy} and another processing.

In the present embodiment, in the gyro sensor 1, the detection gain ratio G_{pxy} and the drive gain ratio G_{fxy} of the x axis and the y axis of the resonator 2 are corrected, and the influence of the gain ratio of the detection signal and the drive signal on angle measurement is reduced. In the gyro sensor 1, the PLLs 140 and 141 execute frequency control of drive signals in two independent vibration modes, and the AGCs 130 and 131 execute amplitude control in two independent vibration modes. The gyro sensor 1 includes the first demodulators 111 and 121 that perform demodulation based on one detection signal of the first or second vibration mode and a drive signal of the vibration mode, and the second demodulators 112 and 122 that perform demodulation based on one detection signal of the two vibration modes and the drive signal of the other vibration mode. The gyro sensor 1 includes the first demodulation block 110 including the first demodulator 111 and the second demodulator 112, and the second demodulation block 120 including the first demodulator 121 and the second demodulator 122. Therefore, the gyro sensor 1 can calculate various calculation values Dₓ and D_{y}, the detection gain ratio G_{pxy}, and the drive gain ratios G_{fxy}, θ_{ω}, and Δf by the demodulation outputs of the demodulation blocks 110 and 120 and the calculation using the demodulation outputs. In the gyro sensor 1, θ_{ω} control by the deviation angle corrector 160, the Δf control by the mode match control unit 170, and various feedback of the rotation angle by the angle feedback unit 180 are performed, so that an error in angle or angular velocity measurement is reduced.

(1) In the gyro sensor 1, on the basis of the calculation result of the demodulation blocks 110 and 120, the detection gain ratio corrector 106 multiplies the determinant of the equation (22) by the matrix of the equation (21) including the reciprocal 1/G_{pxy} of the detection gain ratio. As a result, in the gyro sensor 1, a matrix calculation is performed to cancel the non-ideal detection gain ratio G_{pxy} between the x axis and the y axis is performed, and errors in angle and angular velocity measurement due to the influence of the detection gain ratio G_{pxy} are reduced.

(2) In the gyro sensor 1, the drive gain ratio corrector 153 multiplies the matrix of the equation (25) including the reciprocal 1/G_{fxy} of the drive gain ratio by the determinant of the equation (24). As a result, in the gyro sensor 1, a matrix calculation is performed to cancel the non-ideal drive gain ratio G_{fxy} between the x axis and the y axis is performed, and errors in angle and angular velocity measurement due to the influence of the drive gain ratio G_{fxy} are reduced.

(3) The first demodulation block 110 includes the first demodulator 111 that calculates the demodulation outputs V_{Xi1} and V_{Xq1} based on the first detection signal and the first drive signal, and the second demodulator 112 that calculates the demodulation outputs V_{Xi2} and V_{Xq2} based on the first detection signal and the second drive signal. The second demodulation block includes the first demodulator 121 that calculates the demodulation outputs V_{Yi2} and V_{Yq2} based on the second detection signal and the second drive signal, and the second demodulator 122 that calculates the demodulation outputs V_{Yi1} and V_{Yq1} based on the second detection signal and the first drive signal. The control unit 10 includes the deviation angle corrector 160 that calculates the deviation angle θ_{ω} in the resonator 2 on the basis of the calculation values Dₓ and D_{y} calculated by the demodulation blocks 110 and 120 and outputs the control signal Vθ_{ω} of the deviation angle θ_{ω}. As a result, the deviation angle θ_{ω} is minimized, and the accuracy in the control of Δf, that is, the mode match control can be improved.

(4) The control unit 10 includes the mode match control unit 170 that calculates the difference Δf between resonance frequencies of two vibration modes on the basis of frequency signals corresponding to the first and second vibration modes output from the PLL 140 and outputs a signal that controls the Δf. As a result, the mode match control of the resonator 2 becomes possible, and the measurement accuracy of the angle and the angular velocity is improved.

(5) In the gyro sensor 1 according to the present embodiment, measurement errors of the angle and the angular velocity are reduced by a control method including the following first to eighth steps. The first step is to drive the resonator 2 in two axes of the first and second vibration modes by the two independent PLLs 140 and 141 and AGCs 130 and 131. The second step is to calculate and determine the detection gain ratio G_{pxy}, which is a ratio between a gain of the first detection signal from the first detection electrode that detects vibration on the x axis of the resonator 2 and a gain of the second detection signal from the second detection electrode that detects vibration on the y axis of the resonator 2. The third step is to calculate and determine the drive gain ratio G_{fxy}, which is a ratio between a gain of the first drive signal for vibrating the resonator 2 on the x axis and a gain of the second drive signal for vibrating the resonator 2 on the y axis. The fourth step is to perform calculations of the demodulation outputs V_{Xi1}, V_{Xq1}, V_{Xi2}, V_{Xq2}, V_{Yi1}, V_{Yq1}, V_{Yi2}, and V_{Yq2} by the demodulation blocks 110 and 120. The fifth step is to, after the detection gain ratio G_{pxy} is determined, calculate the deviation angle θ_{ω} of the resonator 2 on the basis of the calculation result in the demodulation blocks 110 and 120 and perform feedback control of the deviation angle θ_{ω}. The sixth step is to, after the feedback control of the deviation angle θ_{ω}, calculate the difference Δf between the resonance frequencies of the first and second vibration modes on the basis of the frequency signals corresponding to the first and second vibration modes output from the PLL 140, and perform the feedback control of the Δf. The seventh step is to, after the feedback control of the Δf and the determination of the drive gain ratio G_{fxy}, calculate the rotation angle of the gyro sensor 1 by the integral calculation of the angular velocity, and feed back the calculated rotation angle to the calculation of the rotation angle in the detection direction and the drive direction of the vibration of the resonator 2. The eighth step is to measure the angle and the angular velocity of the gyro sensor 1 after the feeding back the rotation angle.

(6) In the determination of the detection gain ratio G_{pxy}, a matrix calculation is performed to cancel the detection gain ratio by calculating the detection gain ratio G_{pxy} by the demodulation blocks 110 and 120 and multiplying a matrix including 1/G_{pxy}. As a result, the non-ideal detection gain ratio G_{pxy} between the vibration axes x and y of the resonator 2 is cancelled, and errors in angle and angular velocity measurement due to the influence of the detection gain ratio G_{pxy} are reduced.

(7) In the determination of the drive gain ratio G_{fxy}, a matrix calculation is performed to cancel the drive gain ratio G_{fxy} by multiplying a matrix including the reciprocal 1/G_{fxy} of the drive gain ratio. As a result, the non-ideal drive gain ratio G_{fxy} between the vibration axes x and y of the resonator 2 is cancelled, and errors in angle and angular velocity measurement due to the influence of the drive gain ratio G_{fxy} are reduced.

### OTHER EMBODIMENTS

Although having been described in accordance with examples, the present disclosure should not be limited to the examples and structures. The present disclosure also includes various modifications and changes within the range of equivalency. In addition, various combinations and forms, as well as other combinations and forms that include only one element, more, or less, are within the scope and range of spirit of the present disclosure.

In the sensor element, the configuration in which the resonator 2 has a substantially hemispherical shape or a substantially disk shape and the plurality of first electrode portions 51 is arranged so as to surround the resonator 2 has been described as a representative example, but the sensor element is not limited to such a form. For example, in the gyro sensor 1, as long as the sensor element can be regarded as the vibrating body of the two-degree-of-freedom system illustrated in FIG. 5, the control unit 10 can perform the control described above. Therefore, the form, arrangement, and the like of the resonator 2 and the electrode portions 51 and 52 may be other known forms, arrangement, and the like.

The control unit 10 and a method of the control unit described in the present disclosure may be achieved by a dedicated computer provided by configuring a processor and a memory programmed to execute one or a plurality of functions embodied by a computer program. Alternatively, the control unit 10 and the method of the control unit described in the present disclosure may be achieved by a dedicated computer provided by configuring a processor with one or more dedicated hardware logic circuits. Alternatively, the control unit 10 and the method of the control unit described in the present disclosure may be achieved by one or more dedicated computers configured by a combination of a processor and a memory programmed to execute one or a plurality of functions and a processor configured by one or more hardware logic circuits. The computer program may be stored in a computer-readable non-transitory tangible recording medium as an instruction executed by a computer.

In each of the embodiments, it goes without saying that the elements constituting the embodiments are not necessarily essential except for a case where it is explicitly stated that the elements are particularly essential and a case where the elements are considered to be obviously essential in principle. In each of the embodiments, when a numerical value such as the number, numerical value, amount, or range of the constituent elements of the embodiment is mentioned, the numerical value is not limited to a specific number unless otherwise specified as essential or obviously limited to the specific number in principle. In each of the embodiments, when referring to the shape, positional relationship, and the like of the constituent elements and the like, the shape, positional relationship, and the like are not limited unless otherwise specified or limited to a specific shape, positional relationship, and the like in principle.

What is claimed is:

1. A gyro sensor comprising:
a resonator having a first vibration mode and a second vibration mode having different resonance angle frequencies;
a mounting substrate including a plurality of electrodes facing the resonator; and
a control unit that executes drive control of the resonator, wherein a radial direction is defined about a virtual straight line along a thickness direction of the mounting substrate and passing through a center of a region surrounded by the plurality of electrodes, an x axis being the radial direction along a vibration direction of the first vibration mode, a y axis being the radial direction along a vibration direction of the second vibration mode,
the control unit includes
a PLL that drives the resonator in two axes of the first vibration mode and the second vibration mode,
a detection gain ratio corrector that corrects a detection gain ratio that is a ratio between a gain of a first detection signal from a first detection electrode that detects vibration of the resonator on the x axis among the plurality of electrodes and a gain of a second detection signal from a second detection electrode that detects vibration of the resonator on the y axis among the plurality of electrodes,
a first coordinate converter that converts a signal from the detection electrode from an actual coordinate axis into a coordinate axis for calculation with a planar coordinate axis formed by the radial direction as the actual coordinate axis,
a drive gain ratio corrector that corrects a drive gain ratio that is a ratio between a gain of a first drive signal to a first drive electrode for vibrating the resonator in the first vibration mode among the plurality of electrodes and a gain of a second drive signal to a second drive electrode for vibrating the resonator in the second vibration mode among the plurality of electrodes,
a second coordinate converter that converts a signal corrected by the drive gain ratio corrector from the coordinate axis for calculation into the actual coordinate axis,
a first demodulation block that calculates a demodulation output used to calculate the detection gain ratio on a basis of the first detection signal,
a second demodulation block that calculates a demodulation output used to calculate the detection gain ratio on a basis of the second detection signal,
an AGC that calculates a drive output that maintains a vibration amplitude of the resonator in the first vibration mode and the second vibration mode, and
an angle feedback unit that includes an integration circuit to calculate, on a basis of information of an angular velocity input from the AGC, a rotation angle by an integration calculation of the angular velocity after the detection gain ratio and the drive gain ratio are corrected, and feeds back the rotation angle calculated to the first coordinate converter and the second coordinate converter.

2. The gyro sensor according to claim 1, wherein, on a basis of a calculation value calculated by the first demodulation block and the second demodulation block, the detection gain ratio corrector performs a matrix calculation to cancel the detection gain ratio by multiplying a matrix including 1/G_{pxy} that is a reciprocal of the detection gain ratio.

3. The gyro sensor according to claim 1, wherein the drive gain ratio corrector performs a matrix calculation to cancel the drive gain ratio by multiplying a matrix including 1/G_{fxy} that is a reciprocal of the drive gain ratio.

4. The gyro sensor according to claim 1, wherein
the first demodulation block includes a first demodulator that calculates a demodulation output based on the first detection signal and the first drive signal, and a second demodulator that calculates a demodulation output based on the first detection signal and the second drive signal,
the second demodulation block includes a third demodulator that calculates a demodulation output based on the second detection signal and the second drive signal, and a fourth demodulator that calculates a demodulation output based on the second detection signal and the first drive signal,
the x axis and the y axis are defined as a vibration axis,
the radial direction along a drive electrode for driving in the first vibration mode and the second vibration mode among the plurality of electrodes is defined as an electrode axis, and
the control unit further includes a deviation angle corrector to calculate, on a basis of a calculation value calculated by the first demodulation block and the second demodulation block, a deviation angle that is an angle formed by the vibration axis and the electrode axis of the resonator, and outputs a control signal of the deviation angle.

5. The gyro sensor according to claim 1, wherein the control unit further includes a mode match control unit that calculates Δf that is a difference between resonance frequencies of the first vibration mode and the second vibration mode on a basis of a frequency signal corresponding to the first vibration mode and a frequency signal corresponding to the second vibration mode output from the PLL, and outputs a signal that controls the Δf.

6. A method for controlling a gyro sensor in which a resonator having a first vibration mode and a second vibration mode having different resonance angle frequencies is mounted on a mounting substrate including a plurality of electrodes facing the resonator, the method comprising:
driving the resonator in two axes of the first vibration mode and the second vibration mode by two independent PLLs and AGCs;
calculating and determining a detection gain ratio that is a ratio between a gain of a first detection signal from a first detection electrode that detects vibration of the resonator on an x axis among the plurality of electrodes and a gain of a second detection signal from a second detection electrode that detects vibration of the resonator on a y axis among the plurality of electrodes, the x axis being a radial direction along a vibration direction of the first vibration mode, the y axis being a radial direction along a vibration direction of the second vibration mode, the radial direction being defined about a virtual straight line along a thickness direction of the mounting substrate and passing through a center of a region surrounded by the plurality of electrodes;
calculating and determining a drive gain ratio that is a ratio between a gain of a first drive signal to a first drive electrode for vibrating the resonator on the x axis among the plurality of electrodes and a gain of a second drive signal to a second drive electrode for vibrating the resonator on the y axis among the plurality of electrodes;
calculating, by a demodulation block, a demodulation output based on the first detection signal and the first drive signal, a demodulation output based on the first detection signal and the second drive signal, a demodulation output based on the second detection signal and the first drive signal, and a demodulation output based on the second detection signal and the second drive signal;
after determining the detection gain ratio, calculating a deviation angle that is an angle between a vibration axis and an electrode axis of the resonator on a basis of a result of calculation in the demodulation block and performing feedback control of the deviation angle, wherein the x axis and the y axis being the vibration axis, the electrode axis being the radial direction along a drive electrode for driving in the first vibration mode and the second vibration mode among the plurality of electrodes;
calculating Δf that is a difference between resonance frequencies of the first vibration mode and the second vibration mode on a basis of a frequency signal corresponding to the first vibration mode and a frequency signal corresponding to the second vibration mode output from the two independent PLLs and performing feedback control of the Δf after performing the feedback control of the deviation angle;
calculating a rotation angle of the gyro sensor by an integral calculation of an angular velocity after performing the feedback control of the Δf and determining the drive gain ratio, and feeding back the rotation angle calculated to calculation of a rotation angle in a detection direction and a rotation angle in a drive direction of vibration of the resonator; and
measuring an angle and an angular velocity of the gyro sensor after feeding back the rotation angle.

7. The method for controlling the gyro sensor according to claim 6, wherein, in the determining of the detection gain ratio, a matrix calculation to cancel the detection gain ratio by calculating the detection gain ratio by the demodulation block and multiplying a matrix including 1/G_{pxy} that is a reciprocal of the detection gain ratio.

8. The method for controlling the gyro sensor according to claim 6, wherein, in the determining of the drive gain ratio, performing a matrix calculation to cancel the drive gain ratio by multiplying a matrix including 1/G_{fxy} that is a reciprocal of the drive gain ratio.
